(19) United States
(12) Patent Application Publication
(10) Pub. No.: US 2026/0134307 A1
(43) Pub. Date: May 14, 2026

(54) SYSTEM FOR PERFORMING INFERENCE USING MIXED PRECISION, NON-TRANSITORY COMPUTER-READABLE STORAGE MEDIUM, AND METHOD FOR PERFORMING INFERENCE USING MIXED PRECISION

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Wencheng LIN, Nisshin-shi (JP); Sakon YAMAMOTO, Nisshin-shi (JP)

(21) Appl. No.: 19/320,347

(22) Filed: Sep. 5, 2025

(30) Foreign Application Priority Data
Nov. 12, 2024 (JP) 2024-197061

(51) Int. Cl. G06N 5/04

(52) U.S. Cl. CPC G06N 5/04

(57) ABSTRACT

A system for executing inference using mixed precision include at least one of (i) a circuit and (ii) a processor with at least one memory storing computer program code executable by the processor. The at least one of the circuit and the processor cause the system to acquire environmental information, which is information regarding environment around an object of the inference. The system also set data types for respective layers to be used in the inference in accordance with the acquired environmental information.

### CROSS REFERENCE TO RELATED APPLICATION

This application is based on and claims the benefits of priority of Japanese Patent Application No. 2024-197061 filed on Nov. 12, 2024. The entire disclosure of which is incorporated herein by reference.

### TECHNICAL FIELD

The present disclosure relates to a system for performing inference using mixed precision, a non-transitory computer-readable storage medium, and a method for performing inference using mixed precision.

### BACKGROUND

Various techniques have been proposed to reduce computation time in inference using an NPU (Neural network Processing Unit).

### SUMMARY

According to at least one embodiment, a system for executing inference using mixed precision include at least one of (I) a circuit and (ii) a processor with at least one memory storing computer program code executable by the processor. The at least one of the circuit and the processor cause the system to acquire environmental information, which is information regarding environment around an object of the inference. The system may set data types for respective layers to be used in the inference in accordance with the acquired environmental information.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating a schematic configuration of a system according to a first embodiment.

FIG. 2 is a diagram illustrating an example of a mixed-precision table.

FIG. 3 is a diagram illustrating an example of configurations (Configs).

FIG. 4 is a flowchart illustrating a procedure of a method for performing inference using mixed precision.

FIG. 5 is a flowchart illustrating a procedure of a method for creating a configuration (Config).

FIG. 6 is a diagram for explaining a method of creating a Config.

### DETAILED DESCRIPTION

To begin with, examples of relevant techniques will be described.

Various techniques have been proposed to reduce computation time in inference using an NPU (Neural network Processing Unit). Technique according to a comparative example uses mixed precision. Mixed precision is a technique that reduces computation time while maintaining inference accuracy by changing a data type for each layer during inference. The data type used for each layer is set in advance.

A surrounding environment changes in real time when using mixed precision for object detection around a vehicle. Therefore, an appropriate data type for each layer may also change from moment to moment. As a result, pre-set data types may no longer be appropriate, leading to issues such as reduced object detection accuracy or increased computation time. Such issues are not limited to vehicles and can also arise in object detection used in environments that change in real time.

According to one aspect of the present disclosure, a system for executing inference using mixed precision include at least one of (i) a circuit and (ii) a processor with at least one memory storing computer program code executable by the processor. The at least one of the circuit and the processor cause the system to acquire environmental information, which is information regarding environment around an object of the inference. The system also set data types for respective layers to be used in the inference in accordance with the acquired environmental information.

According to this configuration, the data types used for the respective layers can be appropriately set in accordance with the environmental information, even when the surrounding environment changes moment by moment. As a result, a decrease in the inference accuracy and an increase in computation time can be reduced.

The present disclosure can be realized as the following embodiments. For example, it can be implemented in the form of a method for performing inference using mixed precision, a computer program for realizing this method, or a non-transitory recording medium storing such a computer program.

### First Embodiment

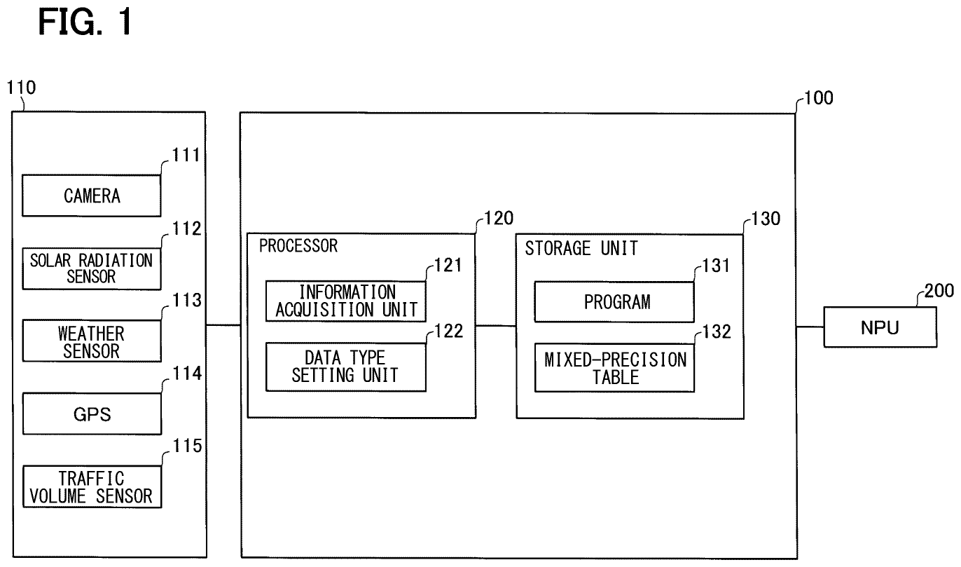

A system 100 of the first embodiment shown in FIG. 1 is used to perform inference using mixed precision. More specifically, the system 100 is used for inference of object detection in an environment surrounding a vehicle. The system 100 in the present embodiment is mounted on the vehicle. The system 100 is connected to an environment information unit 110. The system 100 includes a processor 120 and a storage unit 130.

### <Configuration of Environment Information Unit 110>

The environment information unit 110 detects environmental information and outputs the detected environmental information to the processor 120. The environmental information refers to information about the surroundings of the inference target. The environment information unit 110 includes a camera 111, a solar radiation sensor 112, a weather sensor 113, a road information sensor 114, and a traffic volume sensor 115.

The camera 111 captures images of the surroundings of the vehicle as environmental information. The camera 111 may capture images not only of a front of the vehicle, but also of its sides and rear. A field of view of the camera 111 includes an object to be detected. The camera 111 includes, for example, a CCD (Charge Coupled Device) sensor or a CMOS (Complementary Metal Oxide Semiconductor) sensor. The captured images are outputted to a NPU (Neural network Processing Unit) 200 via the processor 120. The NPU 200 performs inference to detect the object included in the captured images.

The solar radiation sensor 112 detects solar radiation information, which is information about an amount of solar radiation around the vehicle, as environmental information. The solar radiation sensor 112 is, for example, a sensor capable of measuring luminance or brightness. The solar radiation sensor 112 uses the detected amount of solar radiation to determine whether it is day or night around the vehicle and outputs this information to the processor 120.

The weather sensor 113 detects weather information, which is information about weather conditions around the vehicle, as environmental information. The weather information includes whether the weather is clear or rainy. The weather sensor 113 detects, for example, rain adhering to a vehicle's windshield. The weather sensor 113 includes a light-emitting element that irradiates the windshield and a light-receiving element that receives light reflected from the windshield. The weather sensor 113 detects rain by utilizing property that intensity of the reflected light changes depending on whether rain is adhering to the windshield. The weather sensor 113 uses the detected rain to output to the processor 120 whether the surroundings of the vehicle are clear or rainy.

The road information sensor 114 detects road information, which is information regarding a type of road on which the vehicle is traveling, as environmental information. The types of roads include, for example, general roads and expressways. The road information sensor 114 includes a GPS (Global Positioning System) and a database that stores map information. The road information sensor 114 detects whether the road on which the vehicle is traveling is a general road or an expressway, and outputs this information to the processor 120.

The traffic volume sensor 115 detects congestion information around the vehicle as environmental information. The congestion information includes whether there is traffic congestion or no traffic congestion in the area surrounding the vehicle. The traffic volume sensor 115 detects, for example, the number of other vehicles traveling around the vehicle. The traffic volume sensor 115 uses the detected number of other vehicles to determine the presence or absence of traffic congestion and outputs this information to the processor 120.

### <Configuration of Processor 120 and Storage Unit 130>

The processor 120 executes various controls within the system 100. The processor 120 is, for example, a central processing device (i.e., CPU). The storage unit 130 stores various data used in the system 100. The storage unit 130 is constituted by storage devices such as, for example, an HDD (Hard Disk Drive) or an SSD (Solid State Drive). The processor 120, by executing a program 131 stored in the storage unit 130, enables functions of an information acquisition unit 121 and a data type setting unit 122.

The information acquisition unit 121 acquires the environmental information from the environment information unit 110. The data type setting unit 122 sets the data type used for each layer in inference in accordance with the environmental information acquired by the information acquisition unit 121. The layers in inference include, for example, a Convolution layer, a ReLU layer, a Pooling layer, a SoftMax layer, and the like. The data types include, for example, floating-point type (FP) and integer type (INT). The number of bits in the data type is, for example, 8 bits, 16 bits, or 32 bits. Hereinafter, the data type together with its number of bits will be expressed as, for example, “FP32”.

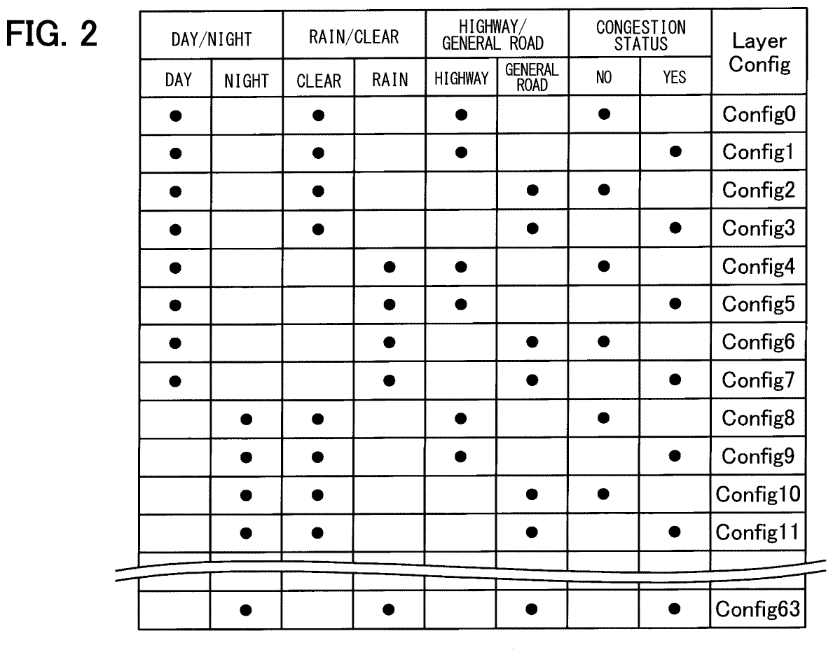

The data type setting unit 122 in the present embodiment determines the data type used for each layer by using the environmental information and a mixed-precision table 132 shown in FIG. 2. The mixed-precision table 132 is stored in advance in the storage unit 130. In the mixed-precision table 132, the environmental information is associated with the data type used for each layer, and these correspondences are stored as a Config. In the present embodiment, the mixed-precision table 132 stores 64 types of Configs, ranging from Config 0 to Config 63. Black circles in the mixed-precision table 132 shown in FIG. 2 indicate the acquired environmental information. For example, when the information acquisition unit 121 acquires, as environmental information, that it is daytime, clear weather, driving on an expressway (highway), and not traffic congestion, the data type setting unit 122 uses Config 0.

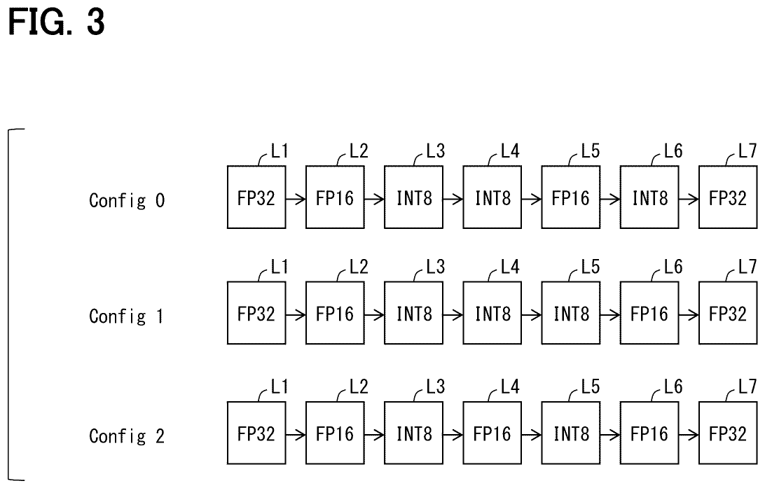

FIG. 3 shows examples of three Configs: Config 0, Config 1, and Config 2. Config 0 to Config 2 store the data types used in each layer. In the example of FIG. 3, seven layers, L1, L2, L3, L4, L5, L6, and L7, are shown. Among these layers L1 to L7, layer L1 is an input layer and layer L7 is an output layer. Accordingly, the mixed precision is applied to intermediate layers, L2 to L6. In the present embodiment, the data types of the input layer L1 and the output layer L7 are FP32. In the present embodiment, in layers L2 to L6, FP16 and INT8 data types are used. In the example shown in FIG. 3, for instance, in Config 0, FP16 is used in layers L2 and L5, while INT8 is used in layers L3, L4, and L6.

The data type setting unit 122 reads each Config from the mixed-precision table 132 and transmits it to the NPU 200 shown in FIG. 1. The NPU 200 performs inference using the mixed precision with the data types specified for each layer by the Config.

<method for Performing Inference Using Mixed Precision>

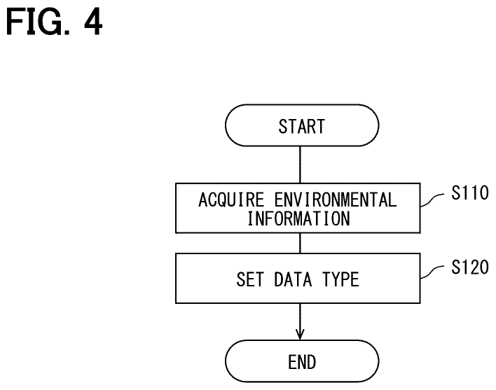

Steps in a flowchart shown in FIG. 4 are used for inference employing the mixed precision. In addition, these steps are executed repeatedly at regular intervals predetermined in advance. For example, these steps are executed every 0.1 seconds. Furthermore, these steps may be executed not only every 0.1 seconds, but also at intervals corresponding to a signal processing cycle for vehicle control. First, the information acquisition unit 121 acquires environmental information (S110). In the present embodiment, the environmental information acquired includes the amount of solar radiation around an inference target, the presence or absence of rain, the type of road, and the presence or absence of traffic congestion.

The data type setting unit 122 sets the data type to be used for each layer in the inference process according to the acquired environmental information (S120). In the present embodiment, the data type used for each layer is predetermined and stored in the storage unit 130 as the mixed-precision table 132.

The NPU 200 performs the inference using the data type determined for each layer by the above method.

### <Method for Creating Config>

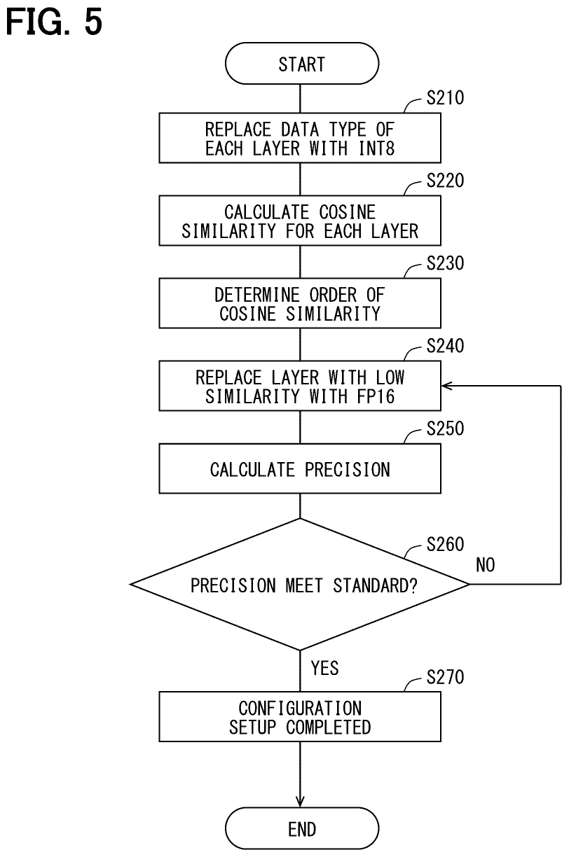

A procedure in a flowchart shown in FIG. 5 is used to create the Config. A method for creating the Config is executed in advance, before performing the inference using the mixed precision. By executing the method for creating the Config multiple times, the mixed-precision table 132 is generated.

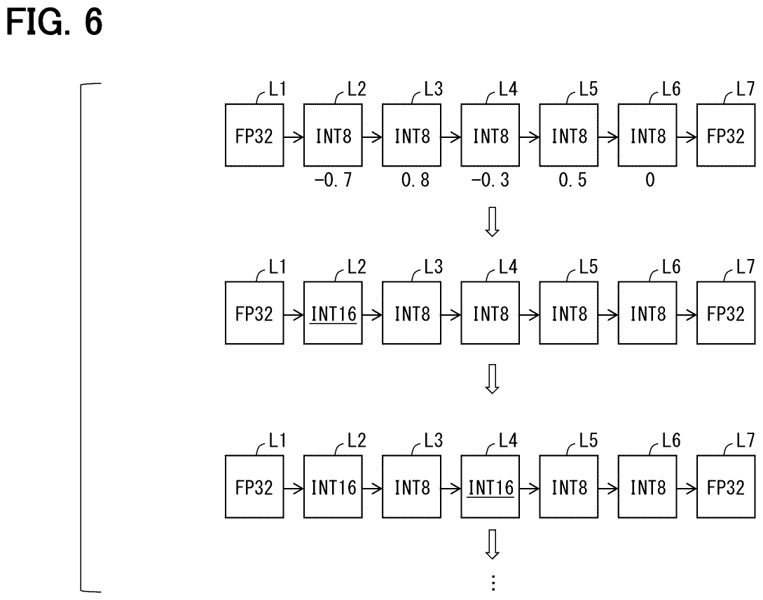

The method for creating the Config will be described with reference to FIGS. 5 and 6. The following describes an example in which the data type used in each layer before applying the mixed precision is FP32 for all layers. In addition, the following description takes as an example a case of creating Config 0 among the Configs shown in FIG. 2. As shown in S210 of FIG. 5 and an upper part of FIG. 6, all of the intermediate layers L2 to L6 to which the mixed precision is to be applied are replaced with a data type of smaller size. In the present embodiment, FP32 is replaced with INT8. Hereinafter, such replacement is also referred to as “quantization”.

As shown in S220 of FIG. 5, cosine similarity is calculated for each of the intermediate layers L2 to L6. More specifically, a comparison is performed between the data type before replacement in S210 and the data type after replacement. The cosine similarity is expressed in a range of −1 to +1, where a value closer to −1 indicates lower similarity, and a value closer to +1 indicates higher similarity. The cosine similarity for each layer is shown below each of layers L2 to L6 in the upper part of FIG. 6. For example, since the cosine similarity of layer L3 is 0.8, the similarity is relatively high, indicating that a quantization error when quantized is relatively small. Contrary to this, since the cosine similarity of layer L2 is −0.7, the similarity is relatively low, indicating that the quantization error when quantized is relatively large.

As shown in S230 of FIG. 5, the order of the cosine similarities of each of layers L2 to L6 is determined. Here, the order is determined such that the layers are arranged from the lowest to the highest cosine similarity. In the example shown in the upper part of FIG. 6, the order is: layer L2, layer L4, layer L6, layer L5, and layer L3.

As shown in S240 of FIG. 5, the layer with the lower cosine similarity is replaced with a larger data amount. In the present embodiment, the replacement is performed in the layer with the lowest cosine similarity among layers L2 to L6. Accordingly, as shown in a middle part of FIG. 6, the layer with the lowest cosine similarity, L2, is replaced from INT8 to INT16.

As shown in S250 of FIG. 5, the inference accuracy is calculated. More specifically, the inference is performed using layers L2 to L6, including layer L2 that was replaced in S240, and the accuracy at that time is calculated. Test data used for the inference includes the environmental information. When creating Config 0 shown in FIG. 2, the test data includes, as the environmental information, that it is daytime, that it is sunny, that the road being driven on is an expressway, and that there is no traffic congestion. The test data is prepared according to the Config to be created.

As shown in S260, it is determined whether the accuracy calculated in S250 meets a predetermined criterion. If the accuracy calculated in S250 meets the predetermined criterion (S260: YES), the setting of the Config is completed as shown in S270.

When the accuracy calculated in S250 does not meet the predetermined criterion (S260: NO), the process returns to S240, and the layer with the second lowest similarity is replaced with a larger amount of data. More specifically, as shown in a lower part of FIG. 6, layer L4, which has the second lowest cosine similarity of −0.3, is replaced from INT8 to INT16. Subsequently, as shown in FIG. 5, the processes of S250 and S260 are executed. When the inference is performed using layers L2 to L6, including the replaced layer L4, and the accuracy still does not meet the criterion, the process returns again to the process of S240, where layer L6 with the third lowest cosine similarity is replaced. In this manner, the processes from S240 to S260 are repeatedly executed until the accuracy in S260 meets the predetermined criterion, or until all layers L2 to L6 have been replaced.

By repeatedly executing the above-mentioned processes S210 to S270, a plurality of Configs are created. As a result, the mixed-precision table 132 is created.

According to the system 100 of the first embodiment described above, since the system 100 has the information acquisition unit 121 that acquires the environmental information, which is information about the surroundings of the inference target, and the data type setting unit 122 that sets the data type used for each layer in the inference according to the acquired environmental information, the data type used for each layer can be appropriately set in accordance with the environmental information, even when the surrounding environment changes moment by moment. It can also be said that the data type used for each layer can be dynamically set. As a result, a decrease in the inference accuracy and an increase in computation time can be reduced.

Further, according to the system 100 of the first embodiment, since the data type setting unit 122 sets the data type used for each layer using the environmental information and the mixed-precision table 132, by storing an appropriate mixed-precision table 132 in advance, the data type used for each layer can be set more appropriately.

Further, according to the system 100 of the first embodiment, since the environmental information includes at least one of the solar radiation information, the weather information, the road information, and the traffic congestion information, the data type setting unit 122 is capable of setting the data type used for each layer more appropriately in accordance with these types of information.

### Other Embodiments

In the first embodiment, the data type setting unit 122 uses the mixed-precision table 132, but the present disclosure is not limited thereto. The data type setting unit 122 may set the data type used for each layer in the inference without using the mixed-precision table 132. For example, the data type setting unit 122 may calculate an appropriate data type to be used for each layer according to the surrounding environment.

In the first embodiment, the environmental information includes the solar radiation information, the weather information, the road information, and the traffic congestion information, but the present disclosure is not limited thereto. The environmental information may be any type of information. The environmental information may include, for example, time information, building information, traffic signal information, pedestrian information, vehicle information, road information, visibility information, noise information, geographic information, obstacle information, temperature information, humidity information, and light environmental information. The time information is information regarding the current time. The building information is information regarding types of surrounding buildings. The traffic signal information is information regarding a color of a signal displayed by a traffic light and a timing of signal changes. The pedestrian information is information regarding a position of pedestrians, a direction and speed of their movement, and density of pedestrians. The vehicle information is information regarding a speed and direction of surrounding vehicles, types of vehicles, a distance between a subject vehicle and other vehicles, and a distances between other vehicles. The road information is information regarding a condition of a road and a condition of a pavement. The visibility information is information regarding clarity of visibility and lighting conditions. The noise information is information regarding an ambient noise level and the presence of specific sounds such as horns or sirens. The geographical information is information regarding GPS data, elevation, and terrain undulation. The obstacle information is information regarding surrounding fixed obstacles, including buildings, guardrails, and trees, as well as moving obstacles, including animals and drones. The temperature information is information regarding an ambient temperature and a road surface temperature. The humidity information is information regarding an ambient humidity and an amount of precipitation. The light environmental information is information regarding intensity of sunlight, a position of shadows, and reflected light. It should be noted that the various types of information included in the environmental information described above are merely examples and do not limit the present disclosure.

In the first embodiment, the weather information included whether it was clear or rainy, but the present disclosure is not limited thereto. The weather information may be any information related to weather. For example, the weather information may simply indicate whether or not it is clear. Additionally, the weather information may include whether it is clear, rainy, cloudy, or snowy.

In the first embodiment, the system 100 is installed in the vehicle, but the present disclosure is not limited thereto. The system 100 may be provided outside the vehicle. For example, the system 100 may be implemented as a server provided outside the vehicle. In this configuration, the environment information unit 110 provides environmental information to the processor 120 using wireless communication or the like.

In the first embodiment, INT8, INT16, and FP32 are used as the data types set by the data type setting unit 122, but the present disclosure is not limited thereto. The data type setting unit 122 may use any data type.

In the first embodiment, the system 100 is used for the object detection in the vehicle, but the present disclosure is not limited thereto. The system 100 may be mounted on any moving object. Further, the system 100 may be used for any type of the inference, not limited to the object detection.

The system 100 and the technique according to the present disclosure may be achieved by a dedicated computer provided by constituting a processor and a memory programmed to execute one or more functions embodied by a computer program. Alternatively, the system 100 described in the present disclosure may be realized by a dedicated computer provided by configuring a processor by one or more dedicated hardware logic circuits. Alternatively, the system 100 and method described in the present disclosure may be implemented using one or more dedicated computers, which include a combination of a processor consisting of one or more hardware logic circuits, and a processor and memory programmed to perform one or more functions. Additionally, the computer program may be stored on a computer-readable non-transitory tangible recording medium as instructions executed by a computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A system for executing inference using mixed precision, comprising:
at least one of (i) a circuit and (ii) a processor with at least one memory storing computer program code executable by the processor, the at least one of the circuit and the processor configured to cause the system to:
acquire environmental information, which is information regarding environment around an object of the inference; and
set data types for respective layers to be used in the inference in accordance with the acquired environmental information.

2. The system according to claim 1, wherein
the at least one memory is configured to store a mixed precision table associating the environmental information and the data types used for the layers, and
the at least one of the circuit and the processor is further configured to cause the system to set the data types for the respective layers to be used by using the environmental information and the mixed precision table.

3. The system according to claim 2, wherein
the inference is executed to detect an object around a vehicle, and
the environmental information includes at least one of solar radiation information relating to an amount of solar radiation around the vehicle, weather information relating to weather around the vehicle, road information relating to a type of road around the vehicle, or congestion information relating to a traffic congestion status around the vehicle.

4. A non-transitory computer readable medium storing a computer program code for implementing inference using mixed precision, the computer program comprising instructions configured to, when executed by a processor, cause the processor to:
acquire environmental information, which is information regarding environment around an object of the inference; and
set data types for respective layers to be used in the inference in accordance with the acquired environmental information.

5. A method for executing inference using mixed precision, comprising:
acquiring environmental information, which is information regarding environment around an object of the inference; and
setting data types for respective layers to be used in the inference in accordance with the acquired environmental information.
